(19) United States
(12) Patent Application Publication
(10) Pub. No.: US 2024/0340147 A1
(43) Pub. Date: Oct. 10, 2024

(54) UNIFIED TCI FOR PUSCH AND PUCCH

(71) Applicant: QUALCOMM Incorporated, San Diego, CA (US)

(72) Inventors: Tianyang BAI, Mountain View, CA (US); Yan ZHOU, San Diego, CA (US); Junyi LI, Greentown, PA (US)

(21) Appl. No.: 18/627,361

(22) Filed: Apr. 4, 2024

Related U.S. Application Data
(60) Provisional application No. 63/494,895, filed on Apr. 7, 2023.

(51) Int. Cl. H04L 5/00; H04W 72/232

(52) U.S. Cl. CPC H04L 5/0053; H04L 5/0035; H04L 5/0051; H04W 72/232

(57) ABSTRACT

Apparatus, methods, and computer program products for wireless communication are provided. An example method may include receiving, from a network node, DCI indicative of a TCI update from a first TCI state associated with a first spatial filter and a first SRS set to a second TCI state associated with a second spatial filter and a second SRS resource set. The example method may further include receiving scheduling for a PUSCH. The example method may further include transmitting, to the network node, the PUSCH using a currently active TCI state after a latest SRS resource set associated with the currently active TCI state.

### CROSS REFERENCE TO RELATED APPLICATION(S)

This application claims the benefit of and priority to U.S. Provisional Application Ser. No. 63/494,895, entitled “UNIFIED TCI FOR PUSCH AND PUCCH” and filed on Apr. 7, 2023, which is expressly incorporated by reference herein in its entirety.

### TECHNICAL FIELD

The present disclosure relates generally to communication systems, and more particularly, to wireless communication systems with unified transmission configuration indicator (TCI) state.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. Based at least in part on stored information that is stored in the memory, the at least one processor is configured to cause the apparatus to receive, from a network node, downlink control information (DCI) indicative of a transmission configuration indicator (TCI) update from a first TCI state associated with a first spatial filter and a first sounding reference signal (SRS) set to a second TCI state associated with a second spatial filter and a second SRS resource set. Based at least in part on stored information that is stored in the memory, the at least one processor is configured to cause the apparatus to receive scheduling for a physical uplink shared channel (PUSCH). Based at least in part on stored information that is stored in the memory, the at least one processor is configured to cause the apparatus to transmit, to the network node, the PUSCH using a currently active TCI state after a latest SRS resource set associated with the currently active TCI state.

In another aspect of the disclosure, a method, a computer-readable medium, and an apparatus at a network entity are provided. The apparatus may include a memory and at least one processor coupled to the memory. Based at least in part on stored information that is stored in the memory, the at least one processor is configured to cause the apparatus to transmit, for a UE, DCI indicative of a TCI update from a first TCI state associated with a first spatial filter and a first SRS set to a second TCI state associated with a second spatial filter and a second SRS resource set. Based at least in part on stored information that is stored in the memory, the at least one processor is configured to cause the apparatus to transmit, for the UE, scheduling for a PUSCH. Based at least in part on stored information that is stored in the memory, the at least one processor is configured to cause the apparatus to obtain the PUSCH using a currently active TCI state after a latest SRS resource set associated with the currently active TCI state.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a base station in communication with a UE via a set of beams.

FIG. 5 is a diagram illustrating a set of two TRPs associated with a particular UE.

FIG. 6 is a diagram illustrating example multi-TRP (mTRP) DL channels.

FIG. 7 is a diagram illustrating example DCI indication without DL assignment.

FIG. 8 is a diagram illustrating example communications between a network entity and a UE where beam mismatch happens due to a TCI update.

FIG. 9 is a diagram illustrating example communications between a network entity and a UE where PUSCH is scheduled to be after an SRS on the updated TCI state.

FIG. 10 is a diagram illustrating example communications between a network entity and a UE where an additional aperiodic SRS resource associated with the updated TCI state is transmitted before PUSCH is transmitted on the updated TCI state.

FIG. 11 is a diagram illustrating example communications between a network entity and a UE where application of the updated TCI state is delayed for the PUSCH.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

In some wireless communication systems, a transmission reception point (TRP) may be associated with a particular periodic or semi-periodic (P/SP) sounding reference signal (SRS) resource set for codebook (CB) or non-codebook (NCB). A physical uplink shared channel (PUSCH) may use a same beam as one of the P/SP SRS resource set. When a TCI update takes place in between SRS and PUSCH, a beam mismatch between PUSCH and SRS may occur. Such beam mismatch may cause inefficient processing at the network side, which may in turn decrease overall efficiency of the wireless communication system. Aspects provided herein may address such potential beam mismatch issue between PUSCH and SRS.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

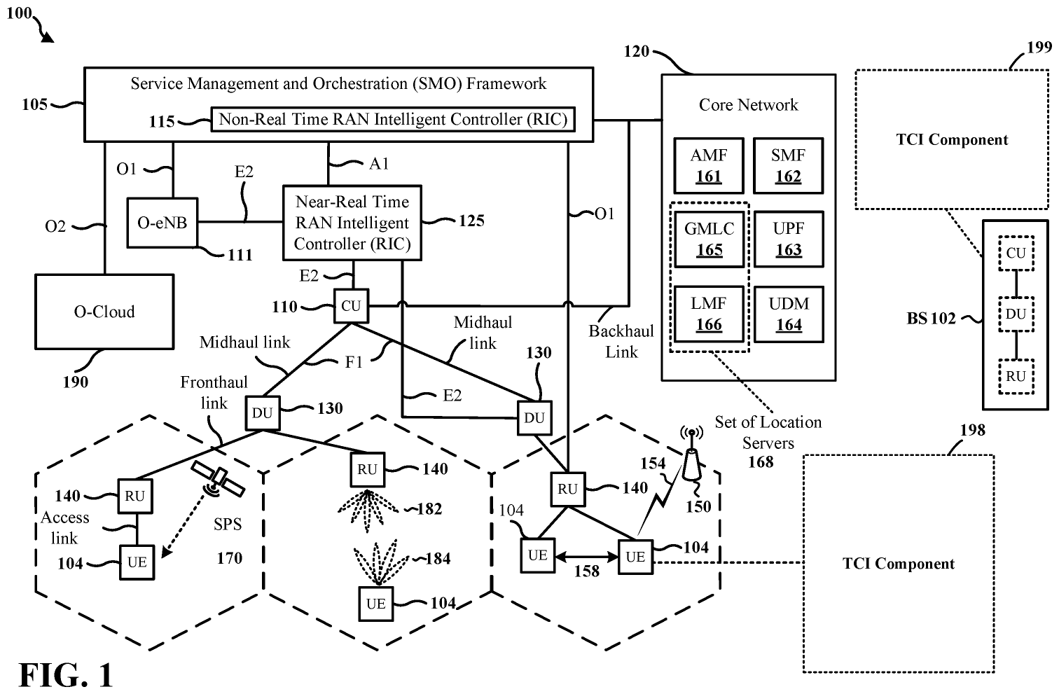

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a TCI component 198. In some aspects, the TCI component 198 may be configured to receive, from a network node, DCI indicative of a TCI update from a first TCI state associated with a first spatial filter and a first SRS set to a second TCI state associated with a second spatial filter and a second SRS resource set. In some aspects, the TCI component 198 may be further configured to receive scheduling for a PUSCH. In some aspects, the TCI component 198 may be further configured to transmit, to the network node, the PUSCH using a currently active TCI state after a latest SRS resource set associated with the currently active TCI state.

In certain aspects, the base station 102 may include a TCI component 199. In some aspects, the TCI component 199 may be configured to transmit, for a UE, DCI indicative of a TCI update from a first TCI state associated with a first spatial filter and a first SRS set to a second TCI state associated with a second spatial filter and a second SRS resource set. In some aspects, the TCI component 199 may be further configured to transmit, for the UE, scheduling for a PUSCH. In some aspects, the TCI component 199 may be further configured to obtain the PUSCH using a currently active TCI state after a latest SRS resource set associated with the currently active TCI state.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

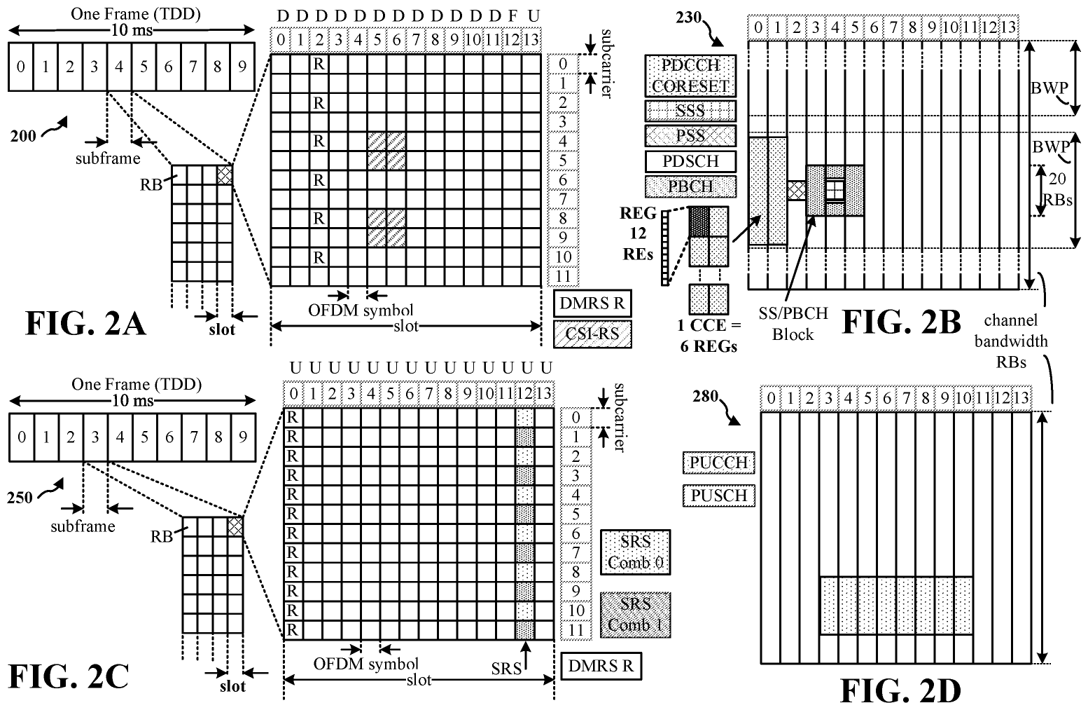

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ=0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

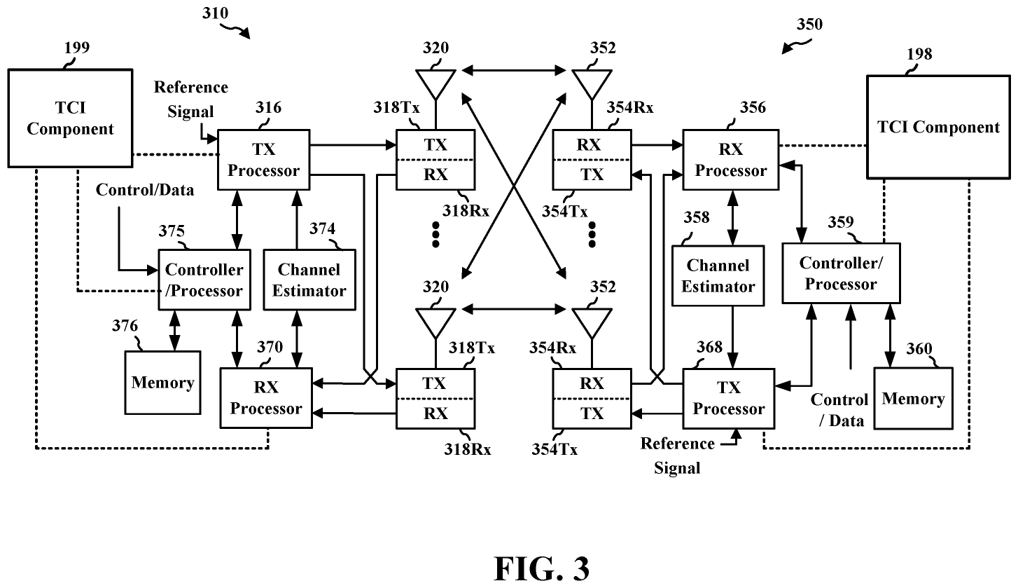

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with TCI component 198 of FIG. 1.

At least one of the TX processor 316, the RX processor 370, and the controller/processor 375 may be configured to perform aspects in connection with TCI component 199 of FIG. 1.

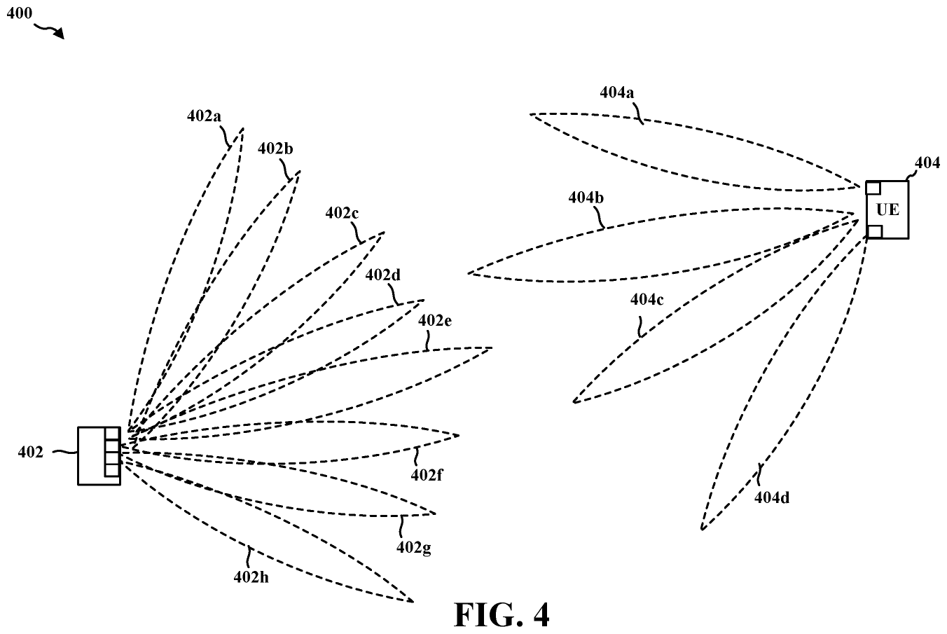

FIG. 4 is a diagram 400 illustrating a base station 402 in communication with a UE 404. Referring to FIG. 4, the base station 402 may transmit a beamformed signal to the UE 404 in one or more of the directions 402a, 402b, 402c, 402d, 402e, 402f, 402g, 402h. The UE 404 may receive the beamformed signal from the base station 402 in one or more receive directions 404a, 404b, 404c, 404d. The UE 404 may also transmit a beamformed signal to the base station 402 in one or more of the directions 404a-404d. The base station 402 may receive the beamformed signal from the UE 404 in one or more of the receive directions 402a-402h. The base station 402/UE 404 may perform beam training to determine the best receive and transmit directions for each of the base station 402/UE 404. The transmit and receive directions for the base station 402 may or may not be the same. The transmit and receive directions for the UE 404 may or may not be the same. The term beam may be otherwise referred to as “spatial filter.” Beamforming may be otherwise referred to as “spatial filtering.” As used herein, the term “beam” may correspond to “spatial filter.”

In response to different conditions, the UE 404 may determine to switch beams, e.g., between beams 402a-402h. The beam at the UE 404 may be used for reception of downlink communication and/or transmission of uplink communication. In some examples, the base station 402 may send a transmission that triggers a beam switch by the UE 404. A TCI state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TC state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the base station 402 may indicate a TCI state change, and in response, the UE 404 may switch to a new beam (which may be otherwise referred to as performing a beam switch) according to the new TCI state indicated by the base station 402.

In some wireless communication systems, such as a wireless communication system under a unified TCI framework, a pool of joint DL/UL TCI states may be used for joint DL/UL TCI state updates for beam indication. For example, the base station 402 may transmit a pool of joint DL/UL TCI states to the UE 404. The UE 404 may determine to switch transmission beams and/or reception beams based on the joint DL/UL TCI states. In some aspects, the TCI state pool for separate DL and UL TCI state updates may be used. In some aspects, the base station 402 may use RRC signaling to configure the TCI state pool. In some aspects, the joint TCI may or may not include UL specific parameter(s) such as UL PC/timing parameters, PLRS, panel-related indication, or the like. If the joint TCI includes the UL specific parameter(s), the parameters may be used for the UL transmission of the DL and UL transmissions to which the joint TCI is applied.

Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like.

A TCI state may be defined to represent at least one source RS to provide a reference (e.g., UE assumption) for determining quasi-co-location (QCL) or spatial filters. For example, a TCI state may define a QCL assumption between a source RS and a target RS.

To accommodate situations where beam indication for UL and DL are separate, two separate TCI states (one for DL and another one for UL) may be utilized. For a separate DL TCI, the source reference signal(s) in M (M being an integer) TCIs may provide QCL information at least for UE-dedicated reception on PDSCH and for UE-dedicated reception on all or subset of CORESETs in a CC. For a separate UL TCI, the source reference signal(s) in N (N being an integer) TCIs provide a reference for determining common UL transmission (TX) spatial filter(s) at least for dynamic-grant or configured-grant based PUSCH and all or subset of dedicated PUCCH resources in a CC.

In some aspects, the UL TX spatial filter may also apply to all SRS resources in resource set(s) configured for antenna switching, codebook-based (CB), or non-codebook-based (NCB) UL transmissions.

In some aspects, each of the following DL RSs may share the same indicated TCI state as UE-dedicated reception on PDSCH and for UE-dedicated reception on all or subset of CORESETs in a CC: CSI-RS resources for CSI, some or all CSI-RS resources for beam management, CSI-RS for tracking, and DM-RS(s) associated with UE-dedicated reception on PDSCH and all/subset of CORESETs. Some SRS resources or resource sets for beam management may share the same indicated TCI state as dynamic-grant/configured-grant based PUSCH, all or subset of dedicated PUCCH resources in a CC. In some wireless communication systems, several QCL rules may be defined. For example, a first rule may define that TCI to DM-RS of UE dedicated PDSCH and PDCCH may not have SSB as a source RS to provide QCL type D information. A second rule may define that TCI to some DL RS such as CSI-RS may have SSB as a source RS to provide QCL type D information. A third rule may define that TCI to some UL RS such as SRS can have SSB as a source RS to provide spatial filter information.

In some wireless communication systems, to facilitate a common TCI state ID update and activation to provide common QCL information at least for UE-dedicated PDCCH/PDSCH (e.g., common to UE-dedicated PDCCH and UE-dedicated PDSCH) or common UL TX spatial filter(s) at least for UE-dedicated PUSCH/PUCCH across a set of configured CCs/BWPs (e.g., common to multiple PUSCH/PUCCH across configured CCs/BWPs), several configurations may be provided. For example, the RRC-configured TCI state pool(s) may be configured as part of the PDSCH configuration (such as in a PDSCH-Config parameter) for each BWP or CC. The RRC-configured TCI state pool(s) may be absent in the PDSCH configuration for each BWP/CC, and may be replaced with a reference to RRC-configured TCI state pool(s) in a reference BWP/CC. For a BWP/CC where the PDSCH configuration contains a reference to the RRC-configured TCI state pool(s) in a reference BWP/CC, the UE may apply the RRC-configured TCI state pool(s) in the reference BWP/CC. When the BWP/CC identifier (ID) (e.g., for a cell) for QCL-Type A or Type D source RS in a QCL information (such as in a QCL info parameter) of the TCI state is absent, the UE may assume that QCL-Type A or Type D source RS is in the BWP/CC to which the TCI state applies. In addition, a UE may report a UE capability indicating a maximum number of TCI state pools that the UE can support across BWPs and CCs in a band.

Before receiving a TCI state, a UE may assume that the antenna ports of one DM-RS port group of a PDSCH are spatially quasi-co-located (QCLed) with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCLed with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). In some aspects, a maximum number of TCI states may be 128.

In some aspects, a UE may receive a signal, from a base station, configured to trigger a TCI state change via, for example, a medium access control (MAC) control element (CE) (MAC-CE), a DCI, or a radio resource control (RRC) signal. The TCI state change may cause the UE to find the best or most suitable UE receive beam corresponding to the TCI state indicated by the base station, and switch to such beam. Switching beams may allow for an enhanced or improved connection between the UE and the base station by ensuring that the transmitter and receiver use the same configured set of beams for communication. A DCI may include one or more TCI codepoints that may each represent one or more TCI states.

In some aspects, a spatial relation change, such as a spatial relation update, may trigger the UE to switch beams. Beamforming may be applied to uplink channels, such as a PUSCH, a PUCCH, or an SRS, or downlink channels, such as PDCCH, PDSCH, or the like. Beamforming may be based on configuring one or more spatial relations between the uplink and downlink signals. Spatial relation indicates that a UE may transmit the uplink signal using the same beam used for receiving the corresponding downlink signal.

In some wireless communication systems, joint TCI for DL and UL may be supported. The source reference signal(s) in M (M being a positive integer) TCIs may provide common QCL information at least for UE-dedicated reception on PDSCH and all or subset of control resource sets (CORESETs) in a component carrier (CC). The source reference signal(s) in N (N being a positive integer) TCIs may provide a reference for determining common UL TX spatial filter(s) at least for dynamic-grant/configured-grant based PUSCH, all or subset of dedicated PUCCH resources in a CC. The UL TX spatial filter may also apply to all SRS resources in resource set(s) configured for antenna switching, codebook-based, or non-codebook-based UL transmissions.

In some wireless communication systems, two separate TCI states, one for DL and one for UL, may be used. For the separate DL TCI, the source reference signal(s) in M TCIs may provide QCL information at least for UE-dedicated reception on PDSCH and for UE-dedicated reception on all or subset of CORESETs in a CC. For the separate UL TCI, the source reference signal(s) in N TCIs may provide a reference for determining common UL TX spatial filter(s) at least for dynamic-grant/configured-grant based PUSCH, all or subset of dedicated PUCCH resources in a CC. The UL TX spatial filter can also apply to all SRS resources in resource set(s) configured for antenna switching, codebook-based, or non-codebook-based UL transmissions.

A wireless device may include M-TRP. Each TRP may include different RF modules having a shared hardware and/or software controller. Each TRP may have separate RF and digital processing. Each TRP may also perform separate baseband processing. Each TRP may include a different antenna panel or a different set of antenna elements of a wireless device. The TRPs of the wireless device may be physically separated. For example, TRPs on a wireless device of a vehicle may be located at different locations of the vehicle. Front and rear antenna panels on a vehicle may be separated by 3 meters, 4 meters, or the like. The spacing between TRPs may vary based on the size of a vehicle and/or the number of TRPs associated with the vehicle. Each of the TRPs may experience a channel differently (e.g., experience a different channel quality) due to the difference physical location, the distance between the TRPs, different line-of-sight (LOS) characteristics (e.g., a LOS channel in comparison to a non-LOS (NLOS) channel), blocking/obstructions, interference from other transmissions, among other reasons.

A single DCI (sDCI) may be used for scheduling DL or UL channels for mTRP (e.g., two TRPs). Operations or channels associated with sDCI for mTRP may be referred to as “sDCI mTRP.” For example, one DCI may be used for scheduling PDSCHs on two different TRPs for a UE.

In some aspects, mDCI may be used for DL or UL channels for mTRP. Operations or channels associated with mDCI for mTRP may be referred to as “mDCI mTRP.” For example, two DCIs may be used for scheduling PDSCHs on two different TRPs for a UE.

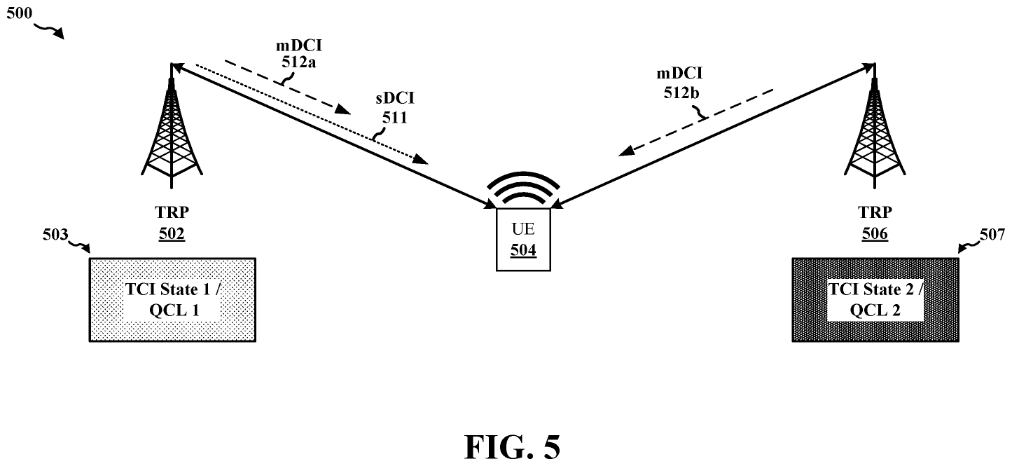

FIG. 5 is a diagram 500 illustrating an example in which a first TRP 502 sends, to a UE 504, an sDCI 511 with scheduling information for downlink communication, such as PDSCH or AP CSI-RS, from the first TRP 502 and the second TRP 506. In some aspects, the mTRP communication may be scheduled by multiple DCI (mDCI), e.g., from the different TRPs. For example, diagram 500 also shows an example in which the TRP 502 sends, to the UE 504, a DCI 512a (e.g., a first DCI in a set of mDCI) scheduling downlink communication, e.g., PDSCH or AP CSI-RS, from the TRP 502, and the TRP 506 sends, to the UE 504, DCI 512b (e.g., a second DCI in the set of mDCI) scheduling downlink communication from the TRP 506. Thus, control and/or data signaling from the TRPs may overlap in time, frequency, and/or spatial directions.

As illustrated, the first TRP 502 may be associated with a first TCI state 503 (e.g., QCL with a first reference signal) and the second TRP 506 may be associated with a second TCI state 507 (e.g., QCL with a second reference signal). Diagram 500 further illustrates that multiple TRPs may coordinate to multiplex communications for at least one UE (e.g., the UE 504) using time division multiplexing (TDM). The TDM may be based on cyclic mapping (e.g., TDM cyclic mapping) in which resources for different TRPs are interspersed. In some aspects, the TDM may be based on sequential mapping (e.g., TDM sequential mapping) in which resources for different TRPs are scheduled in consecutive resources. For example, for the mDCI example, HARQ ACK/NACK feedback for the different TRPs may be based on a single codebook or may be based on different codebooks. In some aspects, PDCCH from multiple TRPs may be transmitted with repetition having different QCL relationships. In some aspect, PUSCH or PUCCH may be transmitted to multiple TRPs in a TDM manner with repetition, or may be simultaneously transmitted with spatial division multiplexing (SDM).

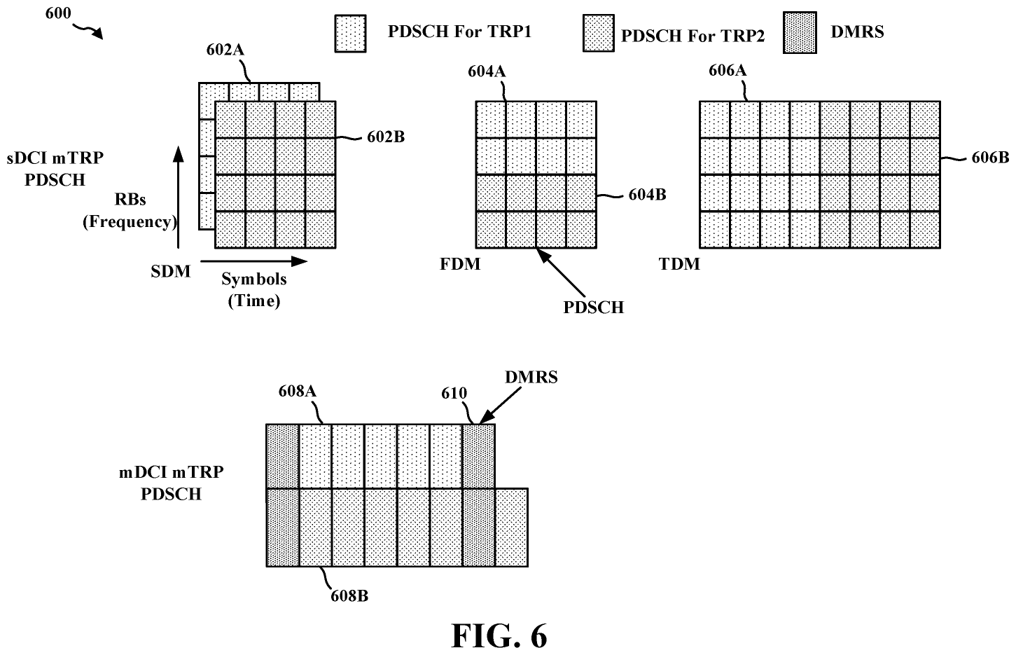

FIG. 6 is a diagram 600 illustrating example mTRP DL channels. As illustrated in FIG. 6, for sDCI mTRP, a first set of PDSCH 602A for a first TRP and a second set of PDSCH 602B for a second TRP may be multiplexed based on spatial division multiplexing (SDM). In some aspects, as illustrated in FIG. 6, for sDCI mTRP, a first set of PDSCH 604A for a first TRP and a second set of PDSCH 604B for a second TRP may be multiplexed based on frequency division multiplexing (FDM). In some aspects, as illustrated in FIG. 6, for sDCI mTRP, a first set of PDSCH 606A for a first TRP and a second set of PDSCH 606B for a second TRP may be multiplexed based on time division multiplexing (TDM). In some aspects, for mDCI mTRP, different DM-RS 610 may be associated with a first set of PDSCH 608A for a first TRP and a second set of PDSCH 608B for a second TRP.

On a general level, unified TCI (which may also be referred to as unified TCI state) may be a DL only type unified TCI which applies to at least UE dedicated PDSCH or PDCCH, a UL only type unified TCI which applies to at least UE dedicated PUSCH or PUCCH, or joint UL/DL type which applies to at least UE dedicated PDSCH, PDCCH, PUSCH, or PUCCH. Unified TCI may be configured in RRC pools and may be activated by MAC control element (MAC CE). DCI format 1_1 or DCI format 1_2 may indicate unified TCI from the activated ones and the indicated unified TCI may be applied to the applicable channel. For example, an activated DL only type TCI may be applied to (by the UE) at least UE dedicated PDSCH or PDCCH, an activated UL only type TCI may be applied to at least UE dedicated PUSCH or PUCCH, and an activated joint UL/DL type may be applied to at least UE dedicated PDSCH, PDCCH, PUSCH, or PUCCH. In some wireless communication systems, one unified TCI state may be indicated by a DCI at a time. However, for some wireless communication systems with mTRP and sDCI, more than one TCI may be indicated by DCI (e.g., a DCI may indicate one TCI per TRP as described in connection with sDCI in FIG. 5).

In some aspects, a unified TCI state may be applied based on the following table:

TABLE 2

| TCI | Applied | |
|---|---|---|
| state | independent of | Applied based on |
| type | RRC configuration | RRC configuration |
| Separate | UE dedicated | Non-UE dedicated PDCCH and |
| DL TCI | PDCCH and PDSCH | PDSCH, aperiodic (AP) CSI-RS |
| | | for CSI, AP CSI RS for beam |
| | | management BM |
| Separate | UE dedicated | SRS for CB/NCB/Antenna |
| UL TCI | PUSCH (dynamic | switching (AS), |
| | grant and configured | AP SRS for BM |
| | grant based) and PUCCH | |
| Joint | UE dedicated | Non-UE dedicated PDCCH and |
| DL and | PDCCH and PDSCH | PDSCH, AP CSI-RS for CSI, AP |
| UL TCI | UE dedicated | CSI RS for BM |
| | PUSCH (dynamic | SRS for CB/NCB/Antenna |
| | grant and configured | switching (AS), AP SRS for BM |
| | grant based) and PUCCH | |

DCI format 0_0 may be a fallback format that may provide scheduling of a PUSCH in one cell. DCI format 0_1 may be a non-fallback format that may provide scheduling of a PUSCH in one cell. DCI format 1_0 may be a fallback DCI format used for allocating downlink resources for a PDSCH. DCI format 1_1 may be a non-fallback DCI format used for allocating downlink resources for a PDSCH. DCI format 2_0 may be used for the notification of slot format information (to dynamically change the slot format). DCI format 2_1 may be used for notifying the PRB(s) and OFDM symbol(s) where a UE may assume no transmission is intended for the UE. DCI format 2_2 may be used for the transmission of transmit power control (TPC) commands for a PUCCH and a PUSCH. DCI format 2_3 may be used for the transmission of a group of TPC commands for SRS transmissions by one or more UEs. DCI format 2_4 may be used for, such as dedicated for, providing cancellation of a UL transmission. A DCI of format 1_1 or 12 may be used to indicate TCI state with or without scheduling any DL assignment. When a DCI with DL assignment is used to indicate TCI state, a TCI field in the DCI may indicate the TCI.

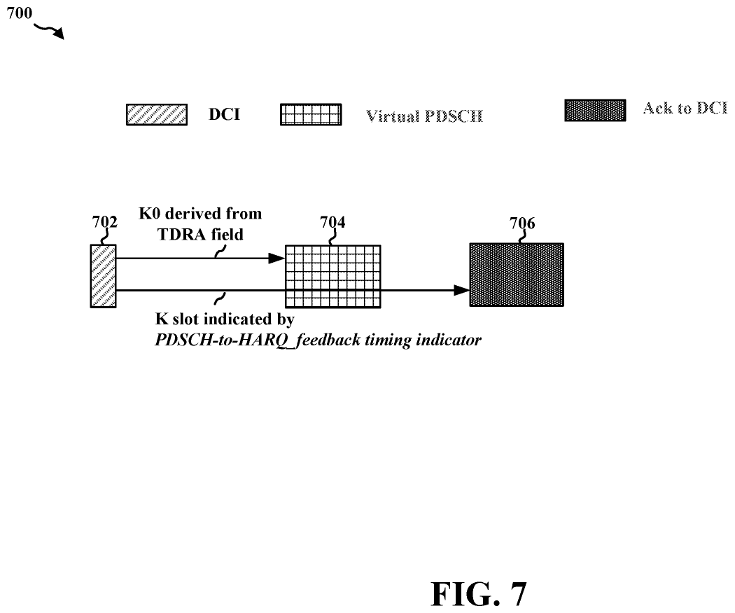

When a DCI without DL assignment is used to indicate TCI state, a cyclic redundancy check (CRC) of the DCI may be scrambled by configured scheduling radio network temporary identifier (CS-RNTI), which may be a UE identification used for semi-persistent scheduling (SPS) in the downlink and configured grant in the uplink. For such a DCI without DL assignment that may be used to indicate TCI state, redundancy version fields may be set to all “1”s, modulation and coding scheme fields may be set to all “1”s, new data indicator field may be set to “0”, and frequency domain resource allocation (FDRA) may be set to all “0”s for FDRA type 0 (based on bitmap), all “1”s for FDRA type 1 (based on start resource block (RB) and number of RBs), or all “0”s for dynamic switch. The TCI field in the DCI may be used to indicate the TCI state ID. A PDSCH-to-HARQ_feedback timing indicator field, if present, may be used to indicate the time offset from the DCI to its associated acknowledgment (ACK) in PUCCH. For type-1 HARQ-ACK codebook, the time domain resource allocation (TDRA) field may be used to derive a virtual PDSCH location, which may be further used to determine a location for the ACK information in the HARQ-ACK codebook. FIG. 7 is a diagram 700 illustrating example DCI indication without DL assignment. As illustrated in FIG. 7, a time between DCI 702 and associated virtual PDSCH 704 may be KG, which may be derived based on TDRA field. A time (e.g., represented by K slots, K being a positive integer) between the DCI 702 and the associated ACK 706 may be indicated by the PDSCH-to-HARQ_feedback timing indicator field.

Multiple TRPs may be deployed to improve spatial diversity of mmW signal reception. For mTRP mDCI, as previously described, each TRP is associated with a respective control resource set (CORESET) pool and each TRP may send its own PDCCH from the associated CORESET to schedule communication from the same TRP. The DCI from a TRP may schedule the communication from the same TRP. The TCI states may be associated with each respective CORESET pool TRP. For mTRP sDCI, as previously described, a single DCI may schedule communication from multiple TRPs. When TCI is activated via MAC-CE, the MAC-CE may map a pair of TCIs, each TCI from a TRP, to a TCI codepoint. A DCI may indicate an index of the TCI codepoint for a communication assignment. The pair of beams (each from a TRP) may be used for the communication. For a specific communication, one of the indicated TCI or both indicated TCIs may be used. CORESET pool may (or may not) be configured, and UE may or may not know the association between TRP and TCI.

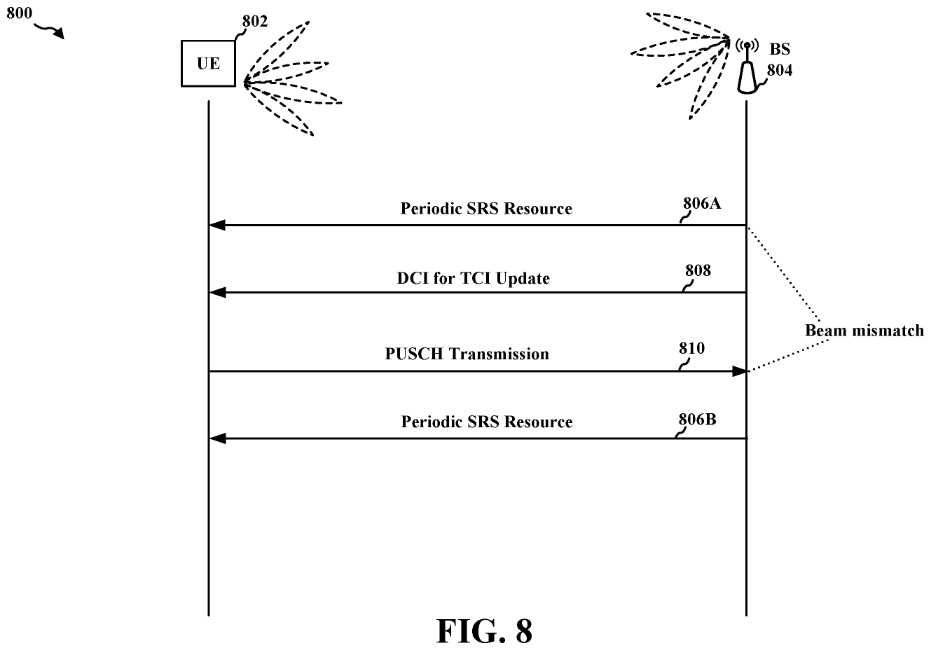

FIG. 8 is a diagram 800 illustrating example communications between a network entity 804 and a UE 802 where beam mismatch happens due to a TCI update. The network entity 804 may be a network node. A network node may be implemented as an aggregated base station, a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some wireless communication systems, a transmission reception point (TRP) may be associated with a particular periodic or semi-periodic (P/SP) sounding reference signal (SRS) resource set for codebook (CB) or non-codebook (NCB). A physical uplink shared channel (PUSCH) may use a same beam as one of the P/SP SRS resource set. Once a TCI state is updated, later SRS resources received by a UE may be based on beam and TRP associated with the updated TCI update. When a TCI update takes place in between SRS and PUSCH, a beam mismatch between PUSCH and SRS may occur.

As illustrated in FIG. 8, the network entity 804 may transmit periodic SRS resources including SRS resource 806A and SRS resource 806B to the UE 802. If the network entity 804 transmits a DCI for TCI update 808 which may cause switching from a first beam to a second beam, and the SRS resource 806A is associated with the first beam, the UE may apply the TCI update based on the DCI for TCI update 808 and switch to the second beam, and then transmit a PUSCH 810 based on SRS resource 806A associated with the first beam, causing a beam mismatch. As a result, the network entity 804 may suffer from decoding failure due to beam mismatch. Such beam mismatch may cause inefficient processing at the network side, which may in turn decrease overall efficiency of the wireless communication system. Aspects provided herein may address such potential beam mismatch issue between PUSCH and SRS.

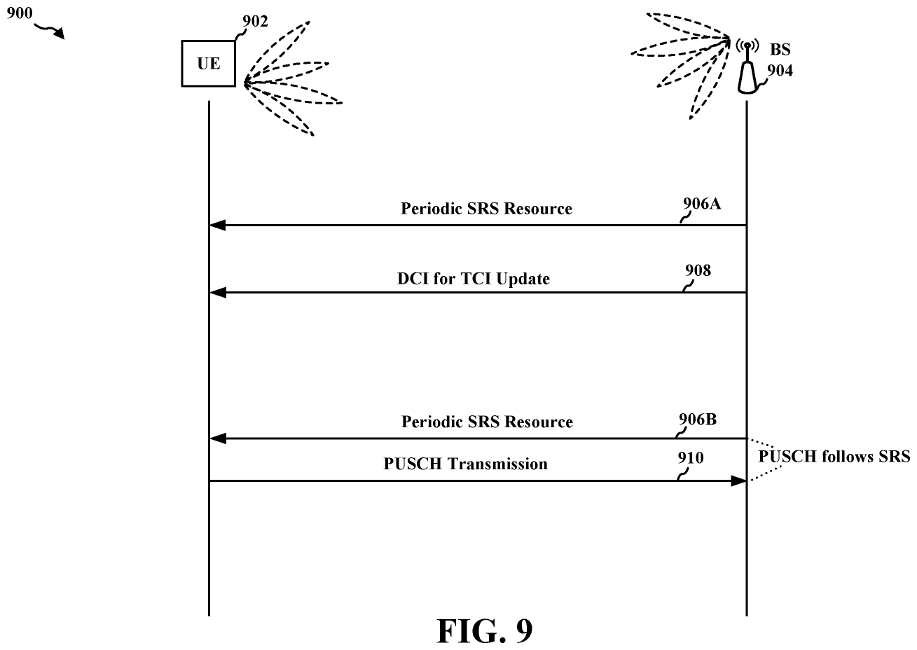

In some aspects, based on implementation of the network entity, the network entity may ensure that a scheduled configured PUSCH on a particular TCI state associated with a particular beam follows (occurs later in time than) a SRS resource on the particular TCI state associated with the particular beam. Therefore, there may be no intervening PUSCH transmission (and the UE may identify an error if there is an intervening PUSCH transmission) between a DCI updating a TCI state and a SRS transmission after the TCI state update. FIG. 9 is a diagram 900 illustrating example communications between a network entity 904 and a UE 902 where PUSCH is scheduled to be after an SRS on the updated TCI state. The network entity 904 may be a network node. A network node may be implemented as an aggregated base station, a disaggregated base station, an IAB node, a relay node, a sidelink node, or the like. A network entity can be implemented in an aggregated or monolithic base station architecture, or alternatively, in a disaggregated base station architecture, and may include one or more of a CU, a DU, a RU, a Near-RT RIC, or a Non-RT RIC. As illustrated in FIG. 9, the network entity 904 may transmit periodic SRS resources including periodic SRS resource 906A and periodic SRS resource 906B to the UE 902. If the network entity 904 transmits a DCI 908 for TCI update which may cause switching from a first beam to a second beam, and the periodic SRS resource 906A is associated with the first beam, the UE may apply the TCI update based on the DCI 908 for TCI update and switch to the second beam, and then transmit a PUSCH 910 after receiving periodic SRS resource 906B associated with the second beam. As a result, there may be no beam mismatch. The network entity 904 may avoid scheduling an intervening PUSCH between the DCI 908 and the periodic SRS resource 906B. If there is an intervening PUSCH scheduled, the UE 902 may identify an error.

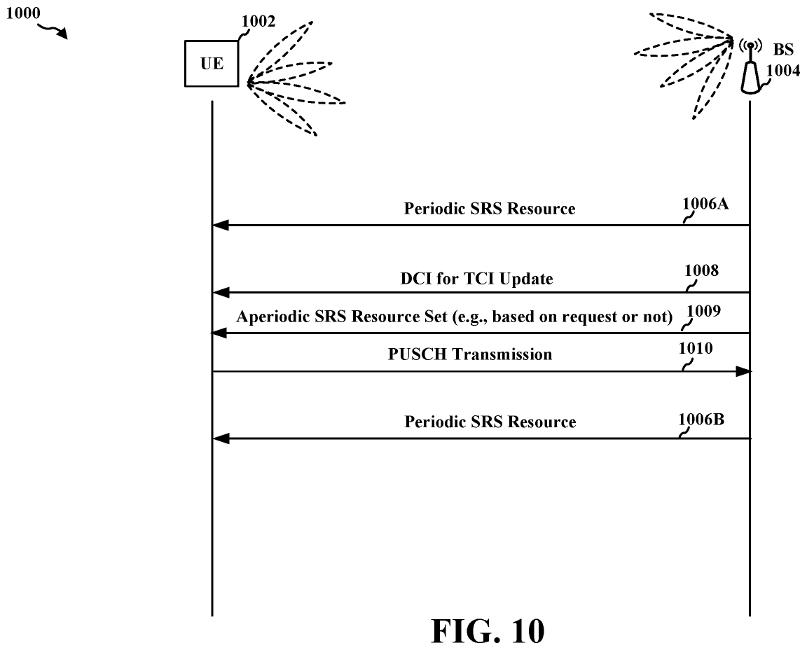

In some aspects, to avoid potential beam mismatch, if there is a PUSCH scheduled or configured on a particular TCI state before any P/SP SRS on the particular TCI state is transmitted, an additional AP SRS may be triggered. FIG. 10 is a diagram 1000 illustrating example communications between a network entity 1004 and a UE 1002 where an additional aperiodic SRS resource associated with the updated TCI state is transmitted before PUSCH is transmitted on the updated TCI state. The network entity 1004 may be a network node. A network node may be implemented as an aggregated base station, a disaggregated base station, an IAB node, a relay node, a sidelink node, or the like. A network entity can be implemented in an aggregated or monolithic base station architecture, or alternatively, in a disaggregated base station architecture, and may include one or more of a CU, a DU, a RU, a Near-RT RIC, or a Non-RT RIC. As illustrated in FIG. 10, the network entity 1004 may transmit periodic SRS resources including periodic SRS resource 1006A and periodic SRS resource 1006B to the UE 1002. If the network entity 1004 transmits a DCI for TCI update 1008 which may cause switching from a first beam to a second beam, and the periodic SRS resource 1006A is associated with the first beam, an additional AP SRS resource (set) 1009 associated with the second beam may be transmitted to the UE 1002. the UE 1002 may apply the TCI update based on the DCI for TCI update 1008 and switch to the second beam, and then transmit a PUSCH 1010 based on the AP SRS resource (set) 1009. In some aspects, the additional AP SRS resource (set) 1009 may be triggered after the TCI update without additional signaling. In some aspects, the additional AP SRS resource (set) 1009 may be triggered after the TCI update based on an request (e.g., from the UE 1002).

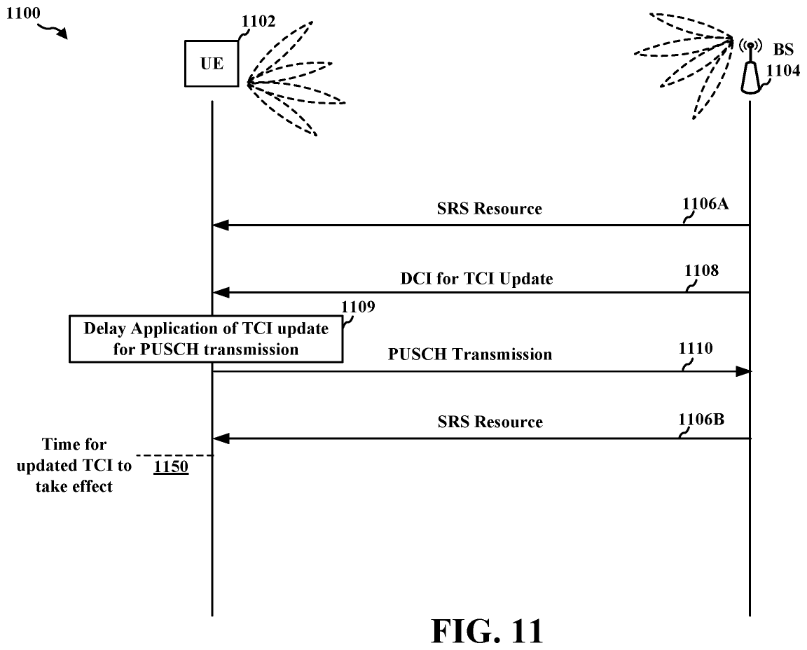

In some aspects, to avoid potential beam mismatch, the time when updated TCI takes effect (e.g., particularly for PUSCH or for all channels) may be delayed until the next P/SP SRS occasion. FIG. 11 is a diagram 1100 illustrating example communications between a network entity 1104 and a UE 1102 where application of the updated TCI state is delayed for the PUSCH. The network entity 1104 may be a network node. A network node may be implemented as an aggregated base station, a disaggregated base station, an IAB node, a relay node, a sidelink node, or the like. A network entity can be implemented in an aggregated or monolithic base station architecture, or alternatively, in a disaggregated base station architecture, and may include one or more of a CU, a DU, a RU, a Near-RT RIC, or a Non-RT RIC. As illustrated in FIG. 11, the network entity 1104 may transmit periodic SRS resources including periodic SRS resource 1106A and periodic SRS resource 1106B to the UE 1102. If the network entity 1104 transmits a DCI for TCI update 1008 which may cause switching from a first beam to a second beam, and the periodic SRS resource 1106A is associated with the first beam, the UE 1102 may delay application of the TCI update for PUSCH transmissions (and may or may not also delay application of the TCI update for other channels, such as PUCCH, PDCCH, PDSCH, or the like) at 1109. The time for the updated TCI to take effect may be delayed to 1150, which is after the periodic SRS resource 1106B associated with the second beam. As a result, the PUSCH 1110 may be transmitted based on the TCI state before the TCI update and based on the associated periodic SRS resource 1106A. As used herein, the term “currently active TCI state” may refer to a TCI state currently configured for PUSCH transmissions.

In some aspects, for mDCI mTRP, for PUCCH transmissions, one of the four options may be applied:
1) A coresetPoolIndex value can be provided per PUCCH resource/resource group, and the UE may apply the indicated joint/UL TCI state specific to the coresetPoolIndex value to the corresponding PUCCH transmission;
2) An RRC configuration can be provided per PUCCH resource/resource group to inform that the UE may apply the first or the second indicated joint/UL TCI state to the corresponding PUCCH transmission, where the first and the second indicated joint/DL TCI states correspond to the indicated joint/UL TCI states specific to coresetPoolIndex value 0 and value 1, respectively;
3) For a PUCCH transmission triggered by PDCCH on a CORESET when the UCI in the PUCCH transmission carries HARQ-ACK information without other information, the UE may apply the indicated joint/UL TCI state specific to a coresetPoolIndex value to the PUCCH transmission, where the coresetPoolIndex value is determined from the one associated with the CORESET. Otherwise, option 1 or option 2 may be applied.
4) For a PUCCH transmission with an LRR trigged for either the first BFD-RS set or the second BFD-RS set when the UE is provided with one or two schedulingRequestID-BFR configuration, the UE may apply the indicated joint/UL TCI state specific to a coresetPoolIndex value to the PUCCH transmission, where the coresetPoolIndex value is 1 when the LRR is trigged for the first BFD-RS set and the coresetPoolIndex value is 0 when the LRR is trigged for the second BFD-RS set. Otherwise, option 1 or option 2 may be applied.

In some aspects, option 3 may be applied when the UE is not provided with ackNackFeedbackMode=joint. In some aspects, when the UE is provided with ackNackFeedbackMode=joint, option 1 or option 2 may be used. In some aspects, when the UE is provided with ackNackFeedbackMode=joint, a default rule which may or may not be configured by the network entity may be used, such as transmitting to both TRPs using two TCIs.

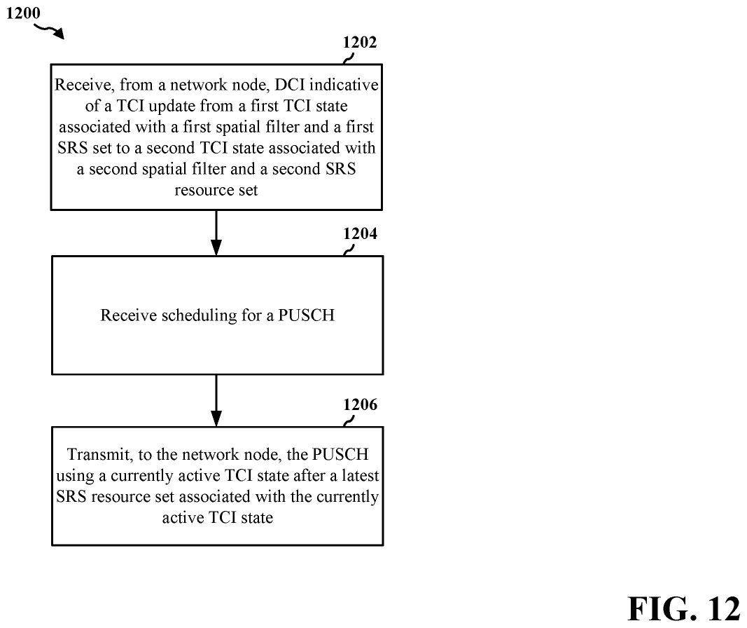

FIG. 12 is a flowchart 1200 of a method of wireless communication. The method may be performed by a UE (e.g., the UE 104, the UE 902, the UE 1002, or the UE 1102; the apparatus 1604).

At 1202, the UE may receive, from a network node, DCI indicative of a TCI update from a first TCI state associated with a first spatial filter and a first SRS set to a second TCI state associated with a second spatial filter and a second SRS resource set. For example, the UE 902, the UE 1002, or the UE 1102 may receive, from a network node (e.g., 904, 1004, or 1104), DCI (e.g., 908, 1008, or 1108) indicative of a TCI update from a first TCI state associated with a first spatial filter and a first SRS set to a second TCI state associated with a second spatial filter and a second SRS resource set. In some aspects, 1202 may be performed by TCI component 198. In some aspects, the TCI update indicates a unified TCI update associated with multiple TRPs, and the PUSCH is scheduled for transmission to at least one of the multiple TRPs. In some aspects, the first spatial filter is associated with a first TRP associated with the network node and the second spatial filter is associated with a second TRP associated with the network node. In some aspects, the TCI update includes an update for a pair of TCI states associated with a first TRP and a second TRP, where the second SRS resource set includes SRS resources for the first TRP and the second TRP, and the transmission of the PUSCH is to the first TRP and the second TRP.

At 1204, the UE may receive scheduling for a PUSCH. For example, the UE 902, the UE 1002, or the UE 1102 may receive scheduling for a PUSCH (e.g., 910, 1010, or 1110). In some aspects, 1204 may be performed by TCI component 198.

At 1206, the UE may transmit, to the network node, the PUSCH using a currently active TCI state after a latest SRS resource set associated with the currently active TCI state. For example, the UE 902, the UE 1002, or the UE 1102 may transmit, to the network node, the PUSCH (e.g., 910, 1010, or 1110) using a currently active TCI state after a latest SRS resource set associated with the currently active TCI state. In some aspects, 1206 may be performed by TCI component 198.

In some aspects, the UE (e.g., UE 902) identifies an error based on an intervening PUSCH being scheduled between the TCI update and the second SRS resource set. In some aspects, the UE (e.g., UE 902) may receive the second SRS resource set (e.g., 906B) and apply the second TCI state after reception of the second SRS resource set.

In some aspects, the second SRS resource set is an aperiodic SRS resource set (e.g., 1009) scheduled based on the TCI update. In some aspects, the UE (e.g., the UE 1002) may receive the second SRS resource set prior to transmission of the PUSCH using the second TCI state, where the second SRS resource set is triggered in response to the TCI update. In some aspects, the UE (e.g., the UE 1002) may transmit a request for the second SRS resource set in response to the TCI update and receive the second SRS resource set in response to the request and prior to transmission of the PUSCH using the second TCI state.

In some aspects, the currently active TCI state is the first TCI state, where the latest SRS resource set is the first SRS resource set (e.g., 1106A). In some aspects, reception of the DCI is before the second SRS resource set, and the UE (e.g., the UE 1102) may delay (e.g., at 1109) an application of the second TCI state until after the reception of the second SRS resource set. In some aspects, reception of the DCI is before the second SRS resource set, and the UE (e.g., the UE 1102) may delay (e.g., at 1109) an application of the second TCI state until after the reception of the second SRS resource set for the PUSCH and transmit a non-PUSCH transmission using the second TCI state after the reception of the DCI and before the second SRS resource set.

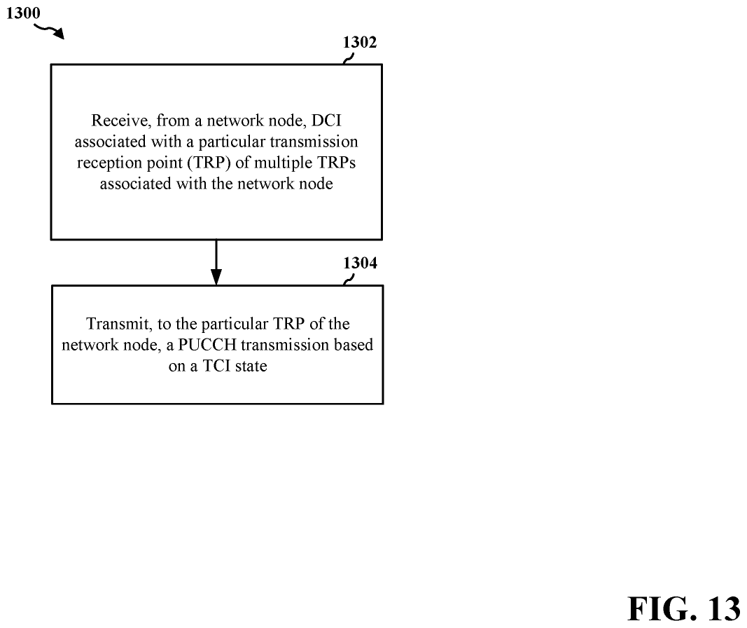

FIG. 13 is a flowchart 1300 of a method of wireless communication. The method may be performed by a UE (e.g., the UE 104, the UE 902, the UE 1002, or the UE 1102; the apparatus 1604).

At 1302, the UE may receive, from a network node, DCI associated with a particular TRP of multiple TRPs associated with the network node. In some aspects, 1302 may be performed by TCI component 198.

At 1304, the UE may transmit, to the particular TRP of the network node, a PUCCH transmission based on a TCI state, where the TCI state is associated with a CORESET pool associated with a PUCCH resource or a PUCCH resource group, the TCI state is associated with a RRC configuration associated with the PUCCH resource or the PUCCH resource group, the PUCCH transmission includes HARQ acknowledgment information and the PUCCH transmission is configured to be triggered by a PDCCH transmission, the TCI state being associated with the CORESET pool, or the PUCCH transmission is configured to be triggered by a link recovery request (LRR), and the TCI state being associated with the CORESET pool associated with a beam failure detection reference signal (BFD RS) set associated with the LRR. In some aspects, 1304 may be performed by TCI component 198. In some aspects, the TCI state is associated with the CORESET pool associated with the PUCCH resource or the PUCCH resource group. In some aspects, the TCI state is associated with the RRC configuration associated with the PUCCH resource or the PUCCH resource group. In some aspects, the PUCCH transmission includes the HARQ acknowledgment information and the PUCCH transmission is configured to be triggered by the PDCCH transmission, the TCI state being associated with the CORESET pool. In some aspects, the UE is configured with an information element indicative of an joint acknowledgment and negative acknowledgment feedback mode. In some aspects, the PUCCH transmission is configured to be triggered by the LRR, and the TCI state being associated with the CORESET pool associated with the BFD RS set associated with the LRR.

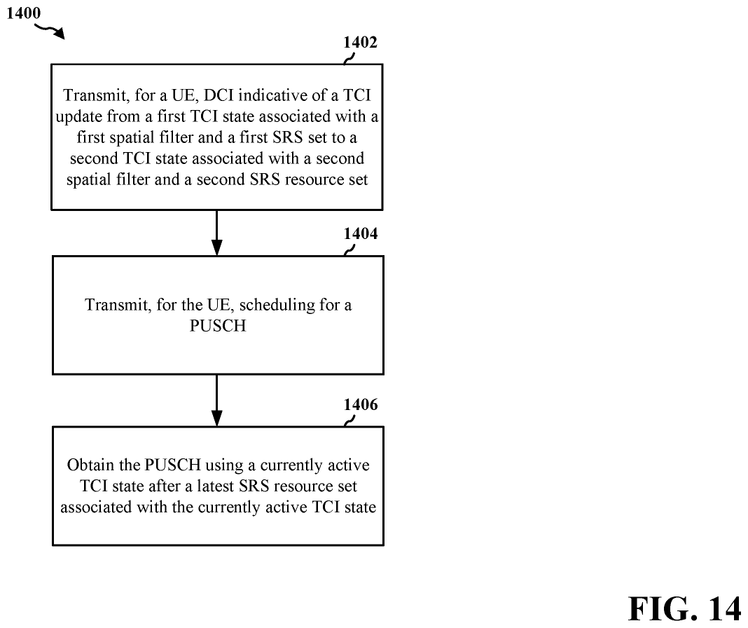

FIG. 14 is a flowchart 1400 of a method of wireless communication. The method may be performed by a network entity (e.g., the base station 102, the network entity 904, the network entity 1004, the network entity 1104, the network entity 1602, the network entity 1702).

At 1402, the network entity may transmit, for a UE, DCI indicative of a TCI update from a first TCI state associated with a first spatial filter and a first SRS set to a second TCI state associated with a second spatial filter and a second SRS resource set. For example, the network entity 904, the network entity 1004, or the network entity 1104 may transmit, for a UE (e.g., 902, 1002, or 1102), DCI (e.g., 908, 1008, or 1108) indicative of a TCI update from a first TCI state associated with a first spatial filter and a first SRS set to a second TCI state associated with a second spatial filter and a second SRS resource set. In some aspects, 1402 may be performed by TCI component 199. In some aspects, the TCI update indicates a unified TCI update associated with multiple TRPs, and the PUSCH is scheduled for transmission to at least one of the multiple TRPs. In some aspects, the first spatial filter is associated with a first TRP associated with the network node and the second spatial filter is associated with a second TRP associated with the network node. In some aspects, the TCI update includes an update for a pair of TCI states associated with a first TRP and a second TRP, where the second SRS resource set includes SRS resources for the first TRP and the second TRP, and the transmission of the PUSCH is to the first TRP and the second TRP.

At 1404, the network entity may transmit, for the UE, scheduling for a PUSCH. For example, the network entity 904, the network entity 1004, or the network entity 1104 may transmit, for the UE, scheduling for a PUSCH (e.g., 910, 1010, or 1110). In some aspects, 1404 may be performed by TCI component 199.

At 1406, the network entity may obtain the PUSCH using a currently active TCI state after a latest SRS resource set associated with the currently active TCI state. For example, the network entity 904, the network entity 1004, or the network entity 1104 may obtain the PUSCH (e.g., 910, 1010, or 1110) using a currently active TCI state after a latest SRS resource set associated with the currently active TCI state. In some aspects, 1406 may be performed by TCI component 199.

In some aspects, the network entity (e.g., network entity 904) may skip scheduling of an intervening PUSCH between the TCI update and the second SRS resource set. In some aspects, the network entity (e.g., network entity 904) may transmit the second SRS resource set (e.g., 906B).

In some aspects, the second SRS resource set is an aperiodic SRS resource set (e.g., 1009) scheduled based on the TCI update. In some aspects, the network entity (e.g., the network entity 1004) may transmit the second SRS resource set prior to transmission of the PUSCH using the second TCI state, where the second SRS resource set is triggered in response to the TCI update. In some aspects, the network entity (e.g., the network entity 1004) may obtain a request for the second SRS resource set in response to the TCI update and receive the second SRS resource set in response to the request and prior to transmission of the PUSCH using the second TCI state.

In some aspects, the currently active TCI state is the first TCI state, where the latest SRS resource set is the first SRS resource set (e.g., 1106A).

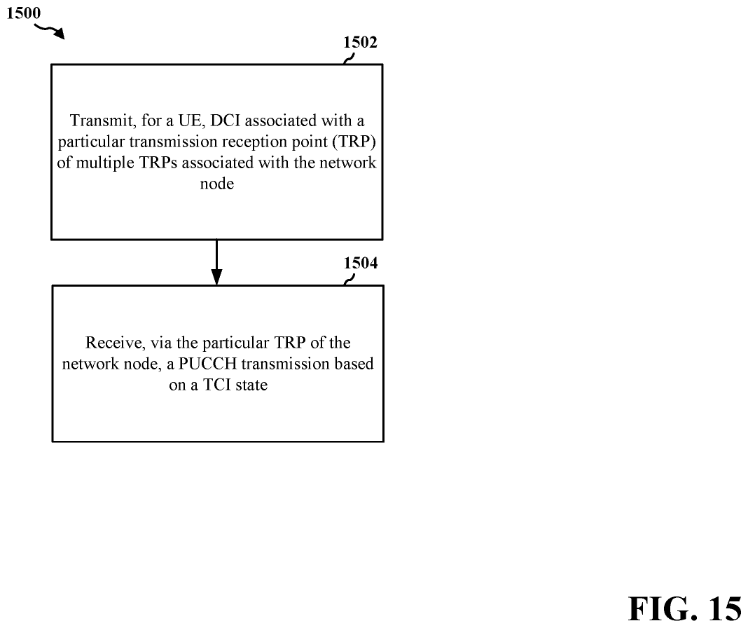

FIG. 15 is a flowchart 1500 of a method of wireless communication. The method may be performed by a network entity (e.g., the base station 102, the network entity 904, the network entity 1004, the network entity 1104, the network entity 1602, the network entity 1702).

At 1502, the network entity may transmit, for a UE, DCI associated with a particular TRP of multiple TRPs associated with the network node. In some aspects, 1502 may be performed by TCI component 199.

At 1504, the network entity may obtain, via the particular TRP of the network node, a PUCCH transmission based on a TCI state, where the TCI state is associated with a CORESET pool associated with a PUCCH resource or a PUCCH resource group, the TCI state is associated with a RRC configuration associated with the PUCCH resource or the PUCCH resource group, the PUCCH transmission includes HARQ acknowledgment information and the PUCCH transmission is configured to be triggered by a PDCCH transmission, the TCI state being associated with the CORESET pool, or the PUCCH transmission is configured to be triggered by a link recovery request (LRR), and the TCI state being associated with the CORESET pool associated with a beam failure detection reference signal (BFD RS) set associated with the LRR. In some aspects, 1504 may be performed by TCI component 199.

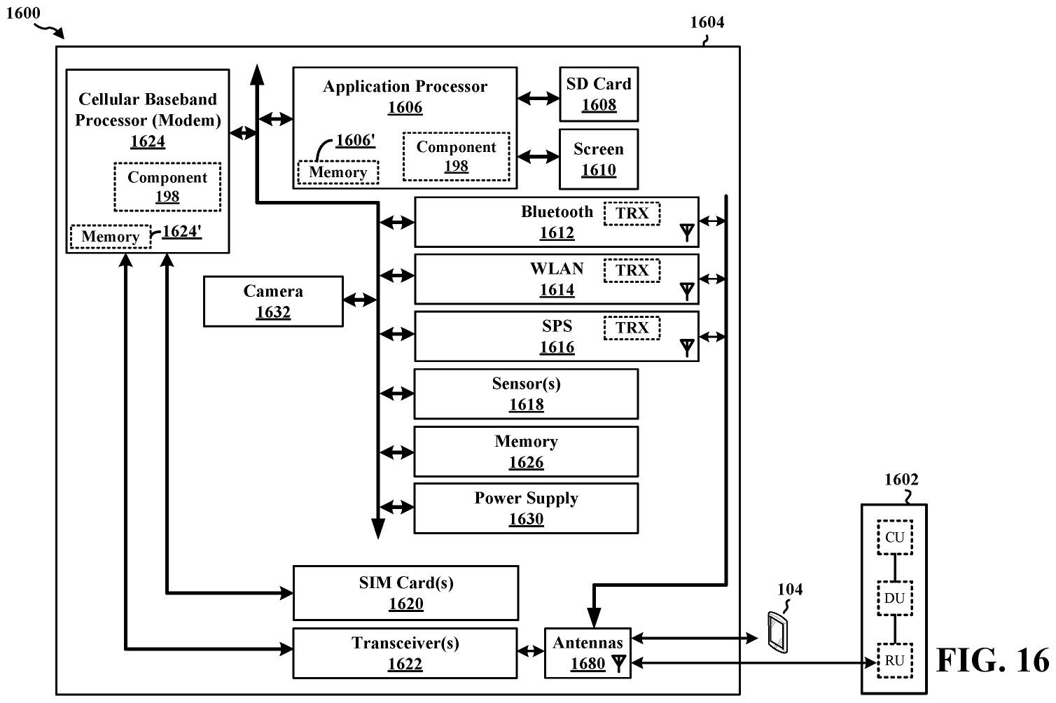

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, a satellite system module 1616 (e.g., GNSS module), one or more sensor modules 1618 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the satellite system module 1616 may include an on-chip transceiver (TRX)/receiver (RX). The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described herein. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed herein, the TCI component 198 may be configured to receive, from a network node, DCI indicative of a TCI update from a first TCI state associated with a first spatial filter and a first SRS set to a second TCI state associated with a second spatial filter and a second SRS resource set. In some aspects, the TCI component 198 may be further configured to receive scheduling for a PUSCH. In some aspects, the TCI component 198 may be further configured to transmit, to the network node, the PUSCH using a currently active TCI state after a latest SRS resource set associated with the currently active TCI state. The TCI component 198 may be within the cellular baseband processor 1624, the application processor 1606, or both the cellular baseband processor 1624 and the application processor 1606. The TCI component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for receiving, from a network node, DCI indicative of a TCI update from a first TCI state associated with a first spatial filter and a first SRS set to a second TCI state associated with a second spatial filter and a second SRS resource set. In some aspects, the apparatus 1604 may further include means for receiving scheduling for a PUSCH. In some aspects, the apparatus 1604 may further include means for transmitting, to the network node, the PUSCH using a currently active TCI state after a latest SRS resource set associated with the currently active TCI state. In some aspects, the apparatus 1604 may further include means for transmitting, for a UE, DCI associated with a particular TRP of multiple TRPs associated with the network node. In some aspects, the apparatus 1604 may further include means for obtaining, via the particular TRP of the network node, a PUCCH transmission based on a TCI state. In some aspects, the apparatus 1604 may further include means for receiving, from a network node, DCI associated with a particular TRP of multiple TRPs associated with the network node. In some aspects, the apparatus 1604 may further include means for transmitting, to the particular TRP of the network node, a PUCCH transmission based on a TCI state. In some aspects, the apparatus 1604 may further include means for receiving the second SRS resource set. In some aspects, the apparatus 1604 may further include means for applying the second TCI state after reception of the second SRS resource set. In some aspects, the apparatus 1604 may further include means for receiving the second SRS resource set prior to transmission of the PUSCH using the second TCI state. In some aspects, the apparatus 1604 may further include means for transmitting a request for the second SRS resource set in response to the TCI update. In some aspects, the apparatus 1604 may further include means for receiving the second SRS resource set in response to the request and prior to transmission of the PUSCH using the second TCI state. In some aspects, the apparatus 1604 may further include means for delaying an application of the second TCI state until after the reception of the second SRS resource set. In some aspects, the apparatus 1604 may further include means for delaying an application of the second TCI state until after the reception of the second SRS resource set for the PUSCH. In some aspects, the apparatus 1604 may further include means for transmitting a non-PUSCH transmission using the second TCI state after the reception of the DCI and before the second SRS resource set. The means may be the TCI component 198 of the apparatus 1604 configured to perform the functions recited by the means. As described herein, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

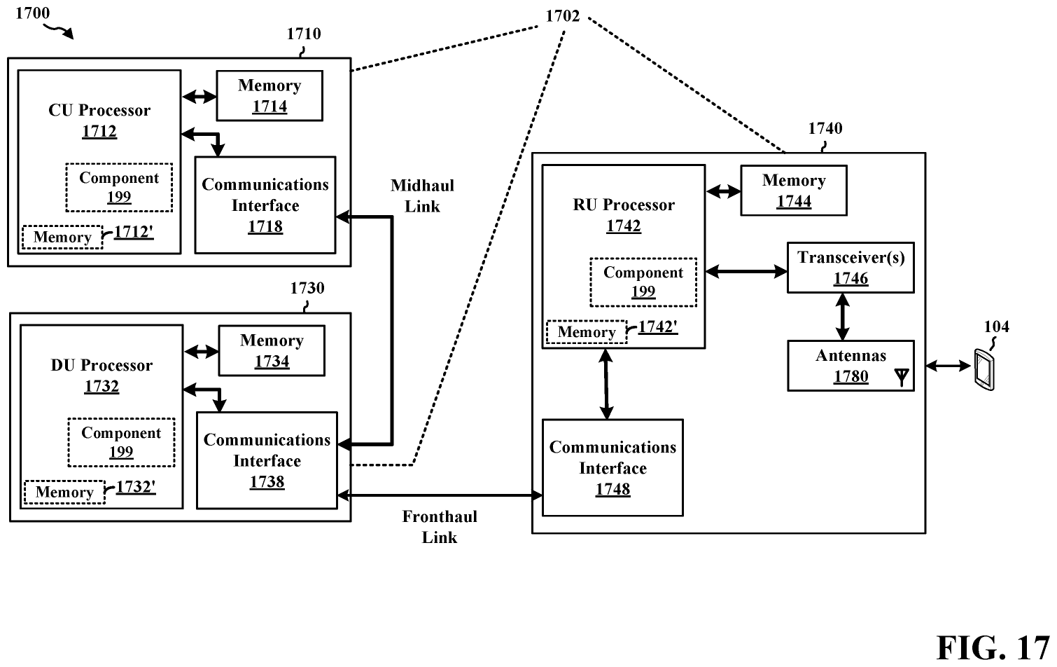

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the TCI component 199 may be configured to transmit, for a UE, DCI indicative of a TCI update from a first TCI state associated with a first spatial filter and a first SRS set to a second TCI state associated with a second spatial filter and a second SRS resource set. In some aspects, the TCI component 199 may be further configured to transmit, for the UE, scheduling for a PUSCH. In some aspects, the TCI component 199 may be further configured to obtain the PUSCH using a currently active TCI state after a latest SRS resource set associated with the currently active TCI state. The TCI component 199 may be within one or more processors of one or more of the CU 1710, DU 1730, and the RU 1740. The TCI component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for transmitting, for a UE, DCI indicative of a TCI update from a first TCI state associated with a first spatial filter and a first SRS set to a second TCI state associated with a second spatial filter and a second SRS resource set. In some aspects, the network entity 1702 may further include means for transmitting, for the UE, scheduling for a PUSCH. In some aspects, the network entity 1702 may further include means for obtaining the PUSCH using a currently active TCI state after a latest SRS resource set associated with the currently active TCI state. In some aspects, the network entity 1702 may further include means for transmitting, for a user equipment (UE), DCI associated with a particular transmission reception point (TRP) of multiple TRPs associated with the network node. In some aspects, the network entity 1702 may further include means for receiving, via the particular TRP of the network node, a PUCCH transmission based on a TCI state. In some aspects, the network entity 1702 may further include means for skipping scheduling an intervening PUSCH between the TCI update and the second SRS resource set. In some aspects, the network entity 1702 may further include means for transmitting the second SRS resource set. In some aspects, the network entity 1702 may further include means for receiving the second SRS resource set prior to transmission of the PUSCH using the second TCI state, where the second SRS resource set is triggered in response to the TCI update. In some aspects, the network entity 1702 may further include means for obtaining a request for the second SRS resource set in response to the TCI update. In some aspects, the network entity 1702 may further include means for transmitting the second SRS resource set in response to the request and prior to transmission of the PUSCH using the second TCI state. The means may be the TCI component 199 of the network entity 1702 configured to perform the functions recited by the means. As described herein, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication at a user equipment (UE), including: receiving, from a network node, downlink control information (DCI) indicative of a transmission configuration indicator (TCI) update from a first TCI state associated with a first spatial filter and a first sounding reference signal (SRS) set to a second TCI state associated with a second spatial filter and a second SRS resource set; receiving scheduling for a physical uplink shared channel (PUSCH); and transmitting, to the network node, the PUSCH using a currently active TCI state after a latest SRS resource set associated with the currently active TCI state.

Aspect 2 is the method of aspect 1, where the TCI update indicates a unified TCI update associated with multiple transmission reception points (TRPs), and the PUSCH is scheduled for transmission to at least one of the multiple TRPs.

Aspect 3 is the method of any of aspects 1-2, where the first spatial filter is associated with a first transmission reception point (TRP) associated with the network node and the second spatial filter is associated with a second TRP associated with the network node.

Aspect 4 is the method of any of aspects 1-3, where the TCI update includes an update for a pair of TC states associated with a first transmission reception point (TRP) and a second TRP, where the second SRS resource set includes SRS resources for the first TRP and the second TRP, and the transmission of the PUSCH is to the first TRP and the second TRP.

Aspect 5 is the method of any of aspects 1-4, further comprising identifying an error based on an intervening PUSCH being scheduled between the TCI update and the second SRS resource set.

Aspect 6 is the method of aspect 5, further including: receiving the second SRS resource set, and applying the second TCI state after reception of the second SRS resource set.

Aspect 7 is the method of any of aspects 1-4, where the second SRS resource set is an aperiodic SRS resource set scheduled based on the TCI update.

Aspect 8 is the method of aspect 7, further including: receiving the second SRS resource set prior to transmission of the PUSCH using the second TCI state, where the second SRS resource set is triggered in response to the TCI update.

Aspect 9 is the method of aspect 7, further including: transmitting a request for the second SRS resource set in response to the TCI update, and receiving the second SRS resource set in response to the request and prior to transmission of the PUSCH using the second TCI state.

Aspect 10 is the method of any of aspects 1-4, where the currently active TCI state is the first TCI state, where the latest SRS resource set is the first SRS resource set.

Aspect 11 is the method of aspect 10, where reception of the DCI is before the second SRS resource set, further including: delaying an application of the second TCI state until after the reception of the second SRS resource set.

Aspect 12 is the method of aspect 10, where reception of the DCI is before the second SRS resource set, further including: delaying an application of the second TCI state until after the reception of the second SRS resource set for the PUSCH, and transmitting a non-PUSCH transmission using the second TCI state after the reception of the DCI and before the second SRS resource set.

Aspect 13 is a method for wireless communication at a user equipment (UE), including: receiving, from a network node, downlink control information (DCI) associated with a particular transmission reception point (TRP) of multiple TRPs associated with the network node; and transmitting, to the particular TRP of the network node, a PUCCH transmission based on a transmission configuration indicator (TCI) state, where: the TCI state is associated with a control resource set (CORESET) pool associated with a physical uplink control channel (PUCCH) resource or a PUCCH resource group, the TCI state is associated with a radio resource control (RRC) configuration associated with the PUCCH resource or the PUCCH resource group, the PUCCH transmission includes hybrid automatic repeat request (HARQ) acknowledgment information and the PUCCH transmission is configured to be triggered by a physical downlink control channel (PDCCH) transmission, the TCI state being associated with the CORESET pool, or the PUCCH transmission is configured to be triggered by a link recovery request (LRR), and the TCI state being associated with the CORESET pool associated with a beam failure detection reference signal (BFD RS) set associated with the LRR.

Aspect 14 is the method of aspect 13, where the TCI state is associated with the CORESET pool associated with the PUCCH resource or the PUCCH resource group.

Aspect 15 is the method of aspect 13, where the TCI state is associated with the RRC configuration associated with the PUCCH resource or the PUCCH resource group.

Aspect 16 is the method of any of aspects 13-15, where the PUCCH transmission includes the HARQ acknowledgment information and the PUCCH transmission is configured to be triggered by the PDCCH transmission, the TCI state being associated with the CORESET pool.

Aspect 17 is the method of aspect 13, where the UE is configured with an information element indicative of an joint acknowledgment and negative acknowledgment feedback mode.

Aspect 18 is the method of aspect 13, where the PUCCH transmission is configured to be triggered by the LRR, and the TCI state being associated with the CORESET pool associated with the BFD RS set associated with the LRR.

Aspect 19 is a method for wireless communication at a network node, including: transmitting, for a user equipment (UE), downlink control information (DCI) indicative of a transmission configuration indicator (TCI) update from a first TCI state associated with a first spatial filter and a first sounding reference signal (SRS) set to a second TCI state associated with a second spatial filter and a second SRS resource set; transmitting, for the UE, scheduling for a physical uplink shared channel (PUSCH); and obtaining the PUSCH using a currently active TCI state after a latest SRS resource set associated with the currently active TCI state.

Aspect 20 is the method of aspect 19, where the TCI update indicates a unified TCI update associated with multiple transmission reception points (TRPs), and the PUSCH is scheduled for transmission to at least one of the multiple TRPs.

Aspect 21 is the method of aspect 20, where the first spatial filter is associated with a first transmission reception point (TRP) associated with the network node and the second spatial filter is associated with a second TRP associated with the network node.

Aspect 22 is the method of any of aspects 20-21, where the TCI update includes an update for a pair of TCI states associated with a first transmission reception point (TRP) and a second TRP, where the second SRS resource set includes SRS resources for the first TRP and the second TRP, and the transmission of the PUSCH is to the first TRP and the second TRP.

Aspect 23 is the method of any of aspects 19-22, further including: skip scheduling an intervening PUSCH between the TCI update and the second SRS resource set.

Aspect 24 is the method of any of aspects 19-23, further including: transmit the second SRS resource set.

Aspect 25 is the method of any of aspects 19-24, where the second SRS resource set is an aperiodic SRS resource set scheduled based on the TCI update.

Aspect 26 is the method of aspect 25, further including: receiving the second SRS resource set prior to transmission of the PUSCH using the second TCI state, where the second SRS resource set is triggered in response to the TCI update.

Aspect 27 is the method of aspect 25, further including: obtaining a request for the second SRS resource set in response to the TCI update, and transmitting the second SRS resource set in response to the request and prior to transmission of the PUSCH using the second TCI state.

Aspect 28 is the method of any of aspects 19-27, where the currently active TCI state is the first TCI state, where the latest SRS resource set is the first SRS resource set.

Aspect 29 is a method for wireless communication at a network node, including: transmitting, for a user equipment (UE), DCI associated with a particular transmission reception point (TRP) of multiple TRPs associated with the network node; and receiving, via the particular TRP of the network node, a PUCCH transmission based on a TCI state, where: the TCI state is associated with a control resource set (CORESET) pool associated with a physical uplink control channel (PUCCH) resource or a PUCCH resource group, the TCI state is associated with a radio resource control (RRC) configuration associated with the PUCCH resource or the PUCCH resource group, the PUCCH transmission includes hybrid automatic repeat request (HARQ) acknowledgment information and the PUCCH transmission is configured to be triggered by a physical downlink control channel (PDCCH) transmission, the TCI state being associated with the CORESET pool, or the PUCCH transmission is configured to be triggered by a link recovery request (LRR), and the TCI state being associated with the CORESET pool associated with a beam failure detection reference signal (BFD RS) set associated with the LRR.

Aspect 30 is an apparatus for wireless communication at a device including a memory and at least one processor coupled to the memory and, based at least in part on information stored in the memory, the at least one processor is configured to implement any of aspects 1 to 18.

Aspect 31 is the apparatus of aspect 29, further including a transceiver or an antenna coupled to the at least one processor.

Aspect 32 is an apparatus for wireless communication at a device including means for implementing any of aspects 1 to 18.

Aspect 33 is a computer-readable medium (e.g., a non-transitory computer-readable medium) storing computer executable code, where the code when executed by a processor causes the processor to implement any of aspects 1 to 18.

Aspect 34 is an apparatus for wireless communication at a device including a memory and at least one processor coupled to the memory and, based at least in part on information stored in the memory, the at least one processor is configured to implement any of aspects 19 to 29.

Aspect 35 is the apparatus of aspect 34, further including a transceiver or an antenna coupled to the at least one processor.

Aspect 36 is an apparatus for wireless communication at a device including means for implementing any of aspects 19 to 29.

Aspect 37 is a computer-readable medium (e.g., a non-transitory computer-readable medium) storing computer executable code, where the code when executed by a processor causes the processor to implement any of aspects 19 to 29.

What is claimed is:

1. An apparatus for wireless communication at a user equipment (UE), comprising:
a memory; and
at least one processor coupled to the memory and, based at least in part on stored information that is stored in the memory, the at least one processor is configured to cause the apparatus to:
receive, from a network node, downlink control information (DCI) indicative of a transmission configuration indicator (TCI) update from a first TCI state associated with a first spatial filter and a first sounding reference signal (SRS) set to a second TCI state associated with a second spatial filter and a second SRS resource set;
receive scheduling for a physical uplink shared channel (PUSCH); and
transmit, to the network node, the PUSCH using a currently active TCI state after a latest SRS resource set associated with the currently active TCI state.

2. The apparatus of claim 1, wherein the TCI update indicates a unified TCI update associated with multiple transmission reception points (TRPs), and the PUSCH is scheduled for transmission to at least one of the multiple TRPs.

3. The apparatus of claim 2, wherein the first spatial filter is associated with a first transmission reception point (TRP) associated with the network node and the second spatial filter is associated with a second TRP associated with the network node.

4. The apparatus of claim 2, wherein the TCI update comprises an update for a pair of TC states associated with a first transmission reception point (TRP) and a second TRP, wherein the second SRS resource set includes SRS resources for the first TRP and the second TRP, and the transmission of the PUSCH is to the first TRP and the second TRP.

5. The apparatus of claim 1, wherein the at least one processor is further configured to cause the apparatus to:
identify an error based on an intervening PUSCH being scheduled between the TCI update and the second SRS resource set.

6. The apparatus of claim 5, wherein the at least one processor is further configured to cause the apparatus to:
receive the second SRS resource set, and
apply the second TCI state after reception of the second SRS resource set.

7. The apparatus of claim 1, wherein the second SRS resource set is an aperiodic SRS resource set scheduled based on the TCI update.

8. The apparatus of claim 7, wherein the at least one processor is further configured to cause the apparatus to:
receive the second SRS resource set prior to transmission of the PUSCH using the second TCI state, wherein the second SRS resource set is triggered in response to the TCI update.

9. The apparatus of claim 7, wherein the at least one processor is further configured to cause the apparatus to:
transmit a request for the second SRS resource set in response to the TCI update, and
receive the second SRS resource set in response to the request and prior to transmission of the PUSCH using the second TCI state.

10. The apparatus of claim 1, wherein the currently active TCI state is the first TCI state, wherein the latest SRS resource set is the first SRS resource set.

11. The apparatus of claim 10, wherein reception of the DCI is before the second SRS resource set, wherein the at least one processor is further configured to cause the apparatus to:
delay an application of the second TCI state until after the reception of the second SRS resource set.

12. The apparatus of claim 10, wherein reception of the DCI is before the second SRS resource set, wherein the at least one processor is further configured to cause the apparatus to:
delay an application of the second TCI state until after the reception of the second SRS resource set for the PUSCH, and
transmit a non-PUSCH transmission using the second TCI state after the reception of the DCI and before the second SRS resource set.

13. An apparatus for wireless communication at a user equipment (UE), comprising:
a memory; and
at least one processor coupled to the memory and, based at least in part on information stored in the memory, the at least one processor is configured to cause the apparatus to:
receive, from a network node, downlink control information (DCI) associated with a particular transmission reception point (TRP) of multiple TRPs associated with the network node; and
transmit, to the particular TRP of the network node, a PUCCH transmission based on a transmission configuration indicator (TCI) state, wherein:
the TCI state is associated with a control resource set (CORESET) pool associated with a physical uplink control channel (PUCCH) resource or a PUCCH resource group,
the TCI state is associated with a radio resource control (RRC) configuration associated with the PUCCH resource or the PUCCH resource group,
the PUCCH transmission comprises hybrid automatic repeat request (HARQ) acknowledgment information and the PUCCH transmission is configured to be triggered by a physical downlink control channel (PDCCH) transmission, the TCI state being associated with the CORESET pool, or
the PUCCH transmission is configured to be triggered by a link recovery request (LRR), and the TCI state being associated with the CORESET pool associated with a beam failure detection reference signal (BFD RS) set associated with the LRR.

14. The apparatus of claim 13, wherein the TCI state is associated with the CORESET pool associated with the PUCCH resource or the PUCCH resource group.

15. The apparatus of claim 13, wherein the TCI state is associated with the RRC configuration associated with the PUCCH resource or the PUCCH resource group.

16. The apparatus of claim 13, wherein the PUCCH transmission comprises the HARQ acknowledgment information and the PUCCH transmission is configured to be triggered by the PDCCH transmission, the TCI state being associated with the CORESET pool.

17. An apparatus for wireless communication at a network node, comprising:
a memory; and
at least one processor coupled to the memory and, based at least in part on stored information that is stored in the memory, the at least one processor is configured to cause the apparatus to:
transmit, for a user equipment (UE), downlink control information (DCI) indicative of a transmission configuration indicator (TCI) update from a first TCI state associated with a first spatial filter and a first sounding reference signal (SRS) set to a second TCI state associated with a second spatial filter and a second SRS resource set;
transmit, for the UE, scheduling for a physical uplink shared channel (PUSCH); and
obtain the PUSCH using a currently active TCI state after a latest SRS resource set associated with the currently active TCI state.

18. The apparatus of claim 17, wherein the TCI update indicates a unified TCI update associated with multiple transmission reception points (TRPs), and the PUSCH is scheduled for transmission to at least one of the multiple TRPs.

19. The apparatus of claim 18, wherein the at least one processor is further configured to cause the apparatus to: skip scheduling an intervening PUSCH between the TCI update and the second SRS resource set.

20. The apparatus of claim 19, wherein the at least one processor is further configured to cause the apparatus to:
transmit the second SRS resource set.
